(19) United States
(12) Patent Application Publication
(10) Pub. No.: US 2002/0003637 A1
(43) Pub. Date: Jan. 10, 2002

(54) Method for alignment of a hologram with an associated substrate

(76) Inventor: Masachika Watanabe, Tokyo (JP)

Correspondence Address: DELLETT AND WALTERS, 310 S.W. FOURTH AVENUE, SUITE 1101, PORTLAND, OR, 97204, US

(21) Appl. No.: 09/870,378

(22) Filed: May 29, 2001

Related U.S. Application Data
(63) Continuation of application No. 09/360,191, filed on Jul. 23, 1999, now abandoned.

(30) Foreign Application Priority Data
Jul. 24, 1998 (JP) 10-209797

(51) Int. Cl. G03H 1/26

(52) U.S. Cl. 359/22

(57) ABSTRACT

The invention is concerned with a hologram alignment mark which is in good alignment with an alignment mark on a hologram plate, and is fabricated by a hologram replication process, and a method for fabricating the same. An alignment mark 22 is provided on the same substrate as provided with a hologram 21, and comprises a reflection hologram having a predetermined outside shape. The reflection hologram comprises interference fringes arranged parallel with one another on a hologram layer surface.

### BACKGROUND OF THE INVENTION

The present invention relates generally to a hologram alignment mark and a method for fabricating the same, and more particularly to a hologram alignment mark located at a given position on a hologram surface and fabricated by a hologram replication process and a method for fabricating the same.

A hologram product should align precisely with a substrate, etc., on which it is to be mounted. For instance, a hologram color filter for liquid crystal display devices proposed by the applicant in Japanese Patent Application No. 5-12170 should be in precise alignment with one of liquid crystal display device substrates.

In this regard, the applicant has filed Japanese Patent Application No. 7-223081 to come up with an alignment mark and method for incorporating a hologram color filter in a liquid crystal display device.

Referring here to the hologram color filter, it comprises an eccentric Fresnel zone plate type of micro-hologram array. Another hologram color filter has also been proposed in the art, which comprises a hologram or diffraction grating made up of parallel and uniform interference fringes and a condensing lens array located on an entrance or exit side thereof. A typical hologram color filter comprising a decentering Fresnel zone plate form of micro-hologram array is here briefly explained.

A liquid crystal display device using the above-mentioned hologram color filter is now explained with reference to a sectional view attached hereto as FIG. 11. As shown, a hologram color filter-forming hologram array 5 is spaced away from the side of a liquid crystal display device 6 regularly divided into liquid crystal cells (pixels) 6′, on which backlight 3 is to be incident. On the back side of the liquid crystal display device 6, a black matrix 4 is located between adjacent liquid crystal cells 6′. Although not illustrated, polarizing plates are positioned on both sides of the liquid crystal display device 6. In this arrangement, it is acceptable to additionally locate between adjacent black matrices 4 an absorption type color filter for transmitting light of colors corresponding to R, G, and B pixels, as is the case with a conventional color liquid crystal display device.

The hologram array 5 comprises an array of micro-holograms 5′ arranged at the same pitch as the repetitive period of R, G, and B color pixels, i.e., corresponding to each set of three liquid crystal cells 6′ in the liquid crystal display device 6, which cells are adjacent to one another on the paper. The micro-hologram 5′ are arranged one by one in alignment with each set of three liquid crystal cells 6′ in the liquid crystal display device 6, which cells are adjacent to one another on the paper. In each micro-hologram 5′, interference fringes are formed into a decentering Fresnel zone plate shape, so that a green component of the backlight 3 incident at an angle θ with respect to the normal to the hologram array 5 can be focused on the central liquid crystal cell G of the three R, G and B color pixels corresponding to the micro-hologram 5′ (an eccentric hologram lens). The micro-hologram 5′ is made up of a transmission hologram of the relief, phase or amplitude type with diffraction efficiency having no or little dependence on wavelength. By the “type with diffraction efficiency having no or little dependence on wavelength” used herein is intended a hologram type capable of diffracting every wavelength with one single diffraction grating, not a hologram type designed to diffract a specific wavelength alone and not to diffract other wavelengths substantially, as is the case with a Lippmann type hologram. A diffraction grating with diffraction efficiency less depending on wavelength diffracts light at an angle of diffraction varying depending on wavelength.

Upon incidence of the white backlight 3 striking from the side of the hologram array 5, which faces away from the liquid crystal display device 6, at the angle θ with respect to the normal thereto, the angle of diffraction through the micro-hologram 5′ varies depending on wavelength, and the focusing position with respect to each wavelength is dispersed in a direction substantially parallel with the surface of the hologram array 5. If the hologram array 5 is designed and arranged in such a manner that red, green, and red wavelength components are diffracted and focused on the positions of a red emitting liquid crystal cell R, a green emitting liquid crystal cell G, and a blue emitting liquid crystal cell B, respectively, the respective color components can then transmit through the respective liquid crystal cells 6′ without substantial attenuation, presenting color displays depending on the states of the liquid crystal cells 6′ at the corresponding positions.

By using the hologram array 5 as a color filter in this manner, it is possible to make the most efficient use of backlight for a conventional color filter because the respective wavelength components of the backlight can be incident on the respective liquid crystal cells 6′ with efficiency and without absorption.

The color filter 5 comprising such a hologram array as mentioned above may be fabricated by a replication process making use of two-beam interference of +first-order multi-point converging light diffracted from a micro-hologram lens array comprising, e.g., a computer-generated hologram, and zero-order transmitted light. This replication process is now briefly explained with reference to a sectional view attached hereto as FIG. 10. Hologram interference fringes for the micro-hologram 5′ (FIG. 11) are computed by a computer. The fringes are written with an electron beam on a glass substrate 1 on which an electron beam resist, for instance, is coated, and then developed to fabricate an array 7′ of a relief type of computer-generated hologram (CGH) 5′. As shown in FIG. 10, a hologram photosensitive material 17 comprising a glass substrate 12, a photopolymer or other photosensitive layer 13 provided thereon and a cover film 14 laminated on the layer 13 is placed on a hologram pattern 2 on the thus obtained CGH array 7′ serving as a hologram plate in a contact or slightly spaced relation thereto. Then, laser light 9 is incident on the CGH array 7′ at an angle θ corresponding to that of the backlight 3 in FIG. 11 to replicate the CGH array 7′ by interference of converging diffracted light 10′formed by each CGH 5″ in the CGH array 7′ and straightforward transmitted light 1 in the photosensitive layer 13 in the hologram photosensitive material 18. It is acceptable to carry out a similar replication process using the thus replicated hologram as a hologram plate, thereby forming the hologram array 5. It is noted that the angle of incidence of the laser light 9 for replication is not necessarily almost equal to the angle θ of incidence of the backlight 3, and the wavelength of the laser light is not necessarily almost equal to that of the backlight 3.

To built a hologram product such as the above hologram color filter 5 in a device to be used therewith, etc., it is required that the hologram product be in precise alignment with a substrate on which it is to be mounted, e.g., a substrate with black matrices 4 provided thereon in the case of the hologram color filter 5.

So far, an alignment mark has been fabricated by providing a patterned metal film on a glass substrate by an evaporation process, etc., and then coating a hologram photosensitive material for hologram replication on the glass substrate.

When a hologram is replicated from a hologram plate on the basis of the alignment mark on the substrate, however, a position error is introduced between the hologram plate and the substrate coated with the hologram photosensitive material, resulting in a drop of the position precision of the alignment mark on the end product. This position precision becomes worse as hologram replication is repeated using the replicated hologram as a hologram plate, resulting in some considerable misalignment of the alignment mark on the end product.

### SUMMARY OF THE INVENTION

In view of such prior art problems as mentioned above, an object of the present invention is to provide a hologram alignment mark which can be fabricated by a hologram replication process while it is in good alignment with an alignment mark on the hologram plate to be replicated, and a method for fabricating the same.

According to the present invention, this object is achieved by the provision of a hologram alignment mark which is an alignment mark provided on the same substrate as a hologram substrate, and comprises a reflection hologram having a predetermined outside shape.

Preferably in this case, the reflection hologram comprises a hologram layer wherein interference fringes are arranged parallel with one another on a hologram layer surface.

For instance, the hologram provided on the same substrate as provided with the alignment mark comprising the reflection hologram may be a transmission hologram.

The present invention also provides a method for fabricating a hologram alignment mark by providing a reflecting member having a predetermined pattern on the same substrate as a substrate for the hologram plate to be replicated, and replicating a hologram from said hologram plate by a hologram replication process, characterized in that by incidence of illumination light on said reflecting member, a reflection hologram having an outside shape corresponding to said pattern on said reflecting member is recorded at a position of a surface of said hologram replicated from said hologram plate, said position corresponding to said reflecting member.

For instance, the hologram plate may comprise a phase hologram which is replicated by a transmission hologram replication process. The reflecting member may be provided at a position of a part of the phase hologram surface.

Moreover, the present invention includes a hologram alignment mark reading method wherein a laser is used as an illumination light source for the reflection hologram or a white light source is used in combination with a filter having a wavelength range substantially identical with a diffraction wavelength of the reflection hologram.

The hologram alignment mark of the present invention is an alignment mark which is provided on the same substrate as a hologram substrate and comprises a reflection hologram having a predetermined outside shape. Even when the replication process is repeated to fabricate holograms, it is thus unnecessary to provide another alignment mark on the glass substrate of the end product, because the alignment mark of the invention is unsusceptible to any displacement and is of high precision.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is a perspective view of one embodiment of the hologram product provided thereon with the hologram alignment mark of the invention.

FIG. 2(a) illustrates one shape of an embodiment of the hologram alignment mark of the invention, and FIG. 2(b) shows one section of that embodiment.

FIG. 3 is a sectional view of one arrangement for replicating a hologram from a hologram plate by a hologram replication process.

FIG. 4 illustrates one embodiment of the outside shape of an alignment mark chromium pattern provided on the hologram plate.

FIG. 5 illustrates one arrangement for carrying out alignment using the hologram alignment mark of the invention.

FIG. 6 illustrates one example of the alignment display monitor screen.

FIG. 7 is an illustration of how the main hologram and hologram alignment mark are replicated using the hologram replicated in the FIG. 3 arrangement as a hologram plate.

FIGS. 8(a) and 8(b) are views of modifications of the FIGS. 3 and 7 replication processes.

FIGS. 9(a), 9(b) and 9(c) are views of an embodiment wherein replication efficiency is improved by replicating a plurality of holograms using a large hologram plate.

FIG. 10 is a sectional view illustrative of a process for replicating a hologram from a hologram plate.

FIG. 11 is a sectional view of a liquid crystal display device using a hologram color filter.

### DESCRIPTION OF THE PREFERRED EMBODIMENTS

The hologram alignment mark and hologram alignment mark fabrication method according to the invention will now be explained with reference to embodiments wherein the hologram alignment mark is used in combination with a hologram color filter.

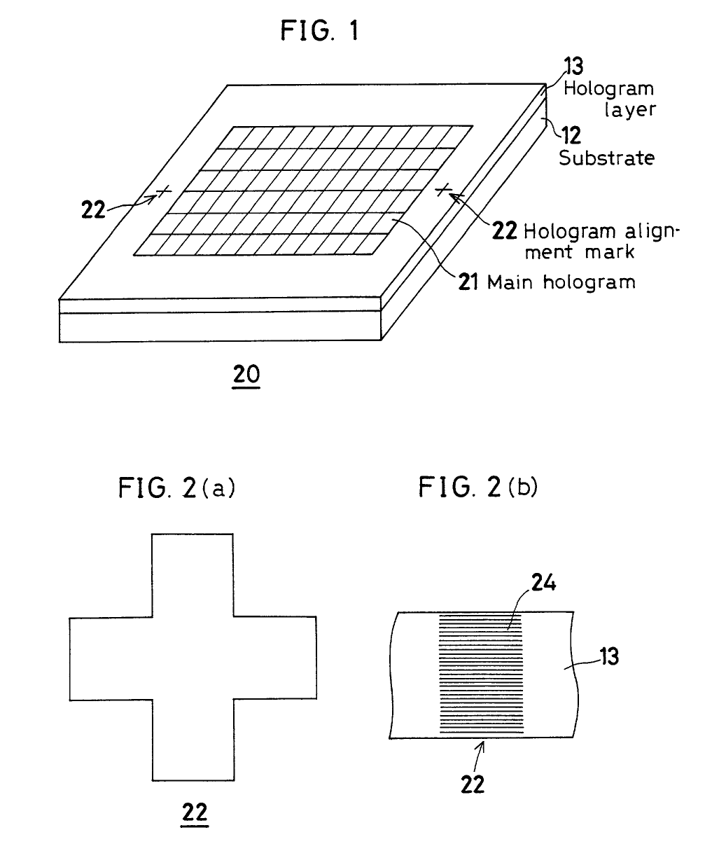

FIG. 1 is a perspective view of a hologram color filter representative of a hologram product. The hologram 20 comprises a hologram layer 13 provided on a glass substrate 12 and formed of a photopolymer or the like. A main hologram 21 comprising a hologram array 5 is recorded on a substantially central region of the hologram layer 13, and hologram alignment marks 22 are provided on the centers of two sides of the main hologram 21 in predetermined position relations thereto. Both the main hologram 21 and the hologram alignment marks 22 comprise phase type volume holograms. More specifically, the main hologram 21 comprises a transmission hologram which is usually transparent and invisible. Each hologram alignment mark 22 is a reflection hologram which, as shown in the FIG. 2(b) sectional view, comprises a so-called hologram mirror made up of interference fringes 24 arranged parallel with one another on a hologram surface of the hologram layer 13. In the invention, the outside shape (or contour) of the reflection hologram 22 is utilized as an alignment mark. The hologram alignment mark 22 has a crosswise outside shape as typically shown in FIG. 2(a).

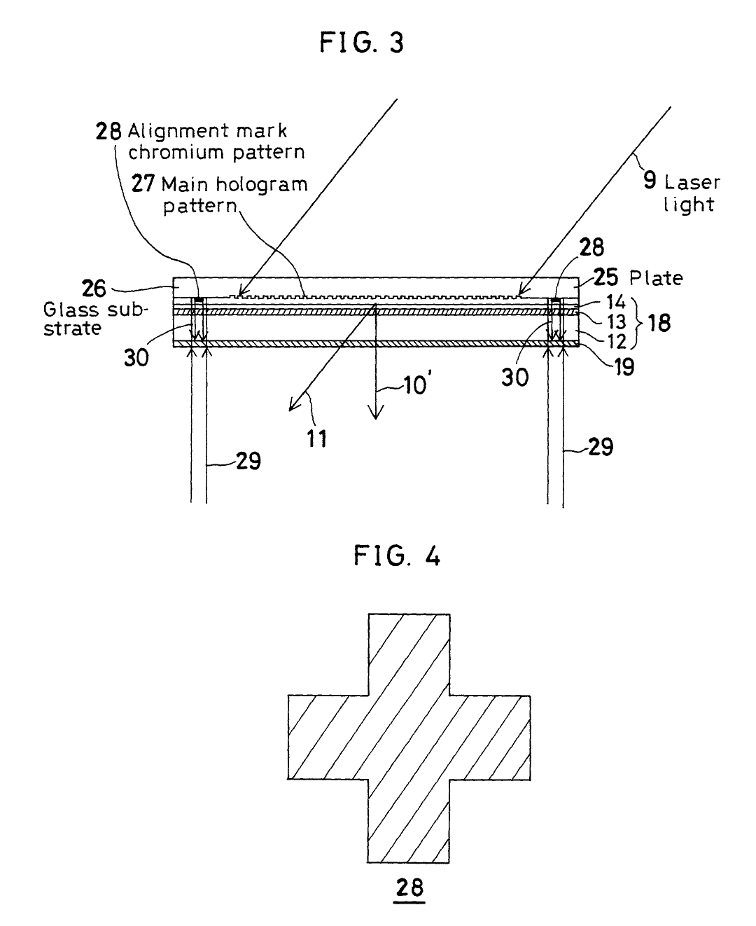

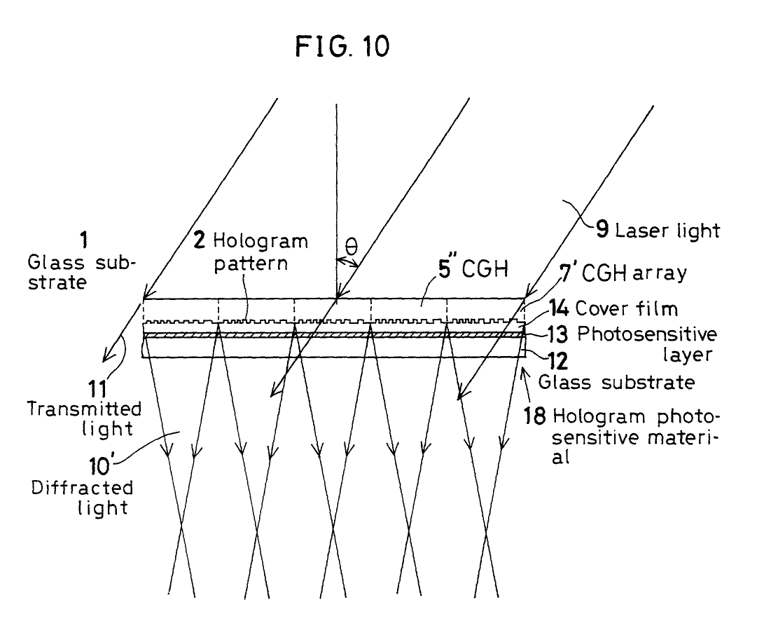

For a better understanding of the hologram alignment mark 22 according to the invention, its fabrication method is first explained. FIG. 3 is a sectional view of an arrangement for recording the main hologram 21 and hologram alignment marks 22 from a hologram plate 25 to be replicated on the same hologram photosensitive material 18 by a hologram replication process. As already explained with reference to FIG. 10, a glass substrate 26 of the hologram plate 25 is provided on a substantially central region of its surface with a main hologram pattern 27 representing hologram interference fringes for the main hologram 21. At the same time, alignment mark chromium patterns 28 are provided in predetermined position relations to the hologram pattern 27. When the hologram alignment mark 22 has a crosswise outside shape as shown in FIG. 2(a), the outside shape of the alignment mark chromium pattern 28 should be congruent with the outside shape of the hologram alignment mark 22, as shown in FIG. 4. In this case, at least the alignment mark chromium pattern 28 should be of reflection capability. Then, a hologram photosensitive layer 18 comprising a glass substrate 12, a photosensitive layer 13 formed of a photopolymer or the like and provided on the glass substrate 12 and a cover film 14 laminated on the photosensitive layer 13 is brought into close contact on the cover film 14 with the alignment mark chromium pattern 28. It is noted that the surface of the glass substrate 12 that faces away from the photosensitive layer 13 in the hologram photosensitive material 18 is provided with an absorption layer 19 which absorbs laser light 9 for the replication of the main hologram and transmits, or does not absorb, laser light 29 for the replication of the hologram alignment marks.

In such an arrangement, the laser light 9 is incident from the side of the hologram plate 25 on the region of the main hologram pattern 27, so that diffracted light 10′ and straightforward transmitted light 11 can interfere with each other in the photosensitive layer 13 in the hologram photosensitive material 18 to replicate the main hologram 21. At the same time as, prior to, or after this, another laser light 29 is incident from the side of the hologram photosensitive material 18 vertically on the region of the alignment mark chromium pattern 28, so that the incident light and light 30 reflected from the alignment mark chromium pattern 28 can interfere with each other in the photosensitive layer 13 in the hologram photosensitive material 18 to fabricate (or replicate) the hologram alignment mark 22. This hologram alignment mark 22 is made up of interference fringes formed by light beams 19 and 20 propagating vertically with respect to the photosensitive layer 13 and in opposite directions to each other. That is, the hologram alignment mark 22 is made up of interference fringes 24 arranged parallel with one another on the hologram surface of the hologram layer 13, as shown in FIG. 2(b). The outside shape of the region with the interference fringes 24 recorded thereon is such that the alignment mark chromium pattern 28 is proximate to the photosensitive layer 13 in the hologram photosensitive material 18, and so is the same as that of the alignment mark chromium pattern 28. To fabricate the hologram alignment mark 22 having the same outside shape as that of the alignment mark chromium pattern 28, it is desired that the cover film 14 in the hologram photosensitive material 18 be as thin as possible, and formed of a material free from double refraction capability.

The absorption layer 19 provided on the surface of the substrate 12 that faces away from the photosensitive layer 13 in the hologram photosensitive material 18 is capable of absorbing the laser light 9 for the replication of the main hologram and incapable of absorbing the laser light 29 for the replication of the hologram alignment mark. When the main hologram 21 is replicated, it is thus possible to prevent multiple reflection of laser light in the glass substrate 12, which may otherwise allow unnecessary interference fringes to be recorded thereon. However, this absorption layer 19 forms no impediment to the replication of the hologram alignment mark 22 because of being capable of transmitting the laser light 29 having a wavelength different from that of the laser light 9. It is noted that when laser light having the same wavelength range is used for the laser light 9 and laser light 29, it is unnecessary to provide the absorption layer 19 on a region corresponding to the alignment mark chromium pattern 28.

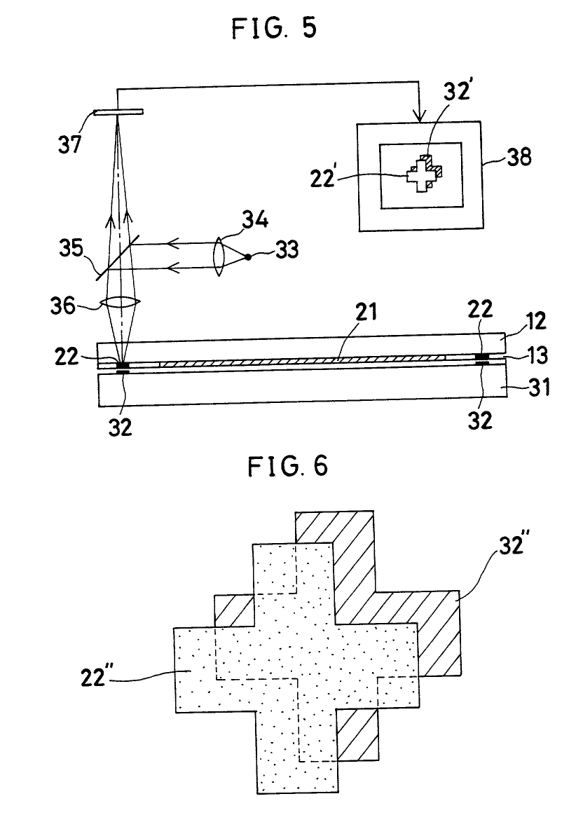

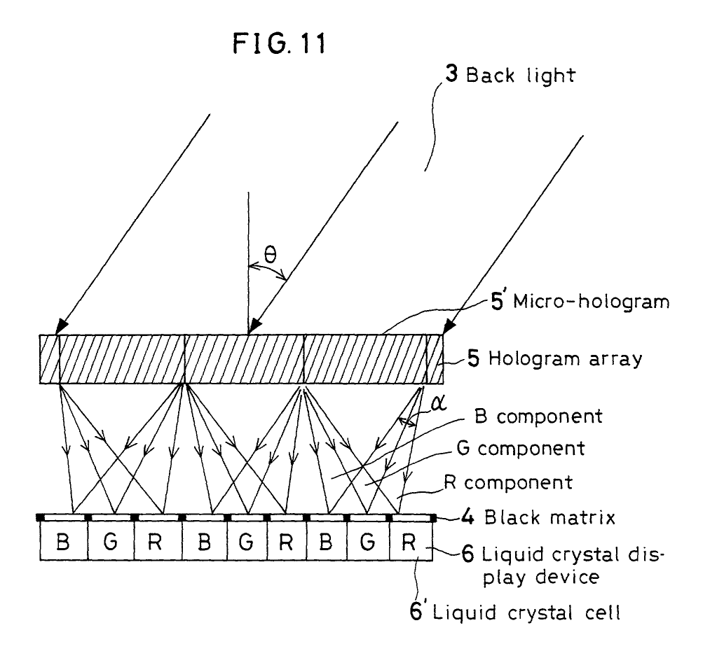

To bring the hologram 20 which is provided on its periphery with the hologram alignment marks 22 as mentioned above in precise alignment with an application substrate 31 of a liquid crystal display device 6 (FIG. 11) provided on its back side with black matrices 4, etc., the hologram 20 and application substrate 31 are brought close to each other, as shown in FIG. 5, so that the hologram alignment marks 22 on the hologram 20 can oppose to alignment marks 32 on the application substrate 31. Each alignment mark 32 may be formed of a pattern which enables an misalignment, if any, from the associated hologram alignment mark 22 to be easily detected. When the hologram alignment mark 22 has a crosswise shape as shown in FIG. 6 (an image 22″ of the mark 22 is shown in FIG. 6), the alignment mark 32, too, should have the same crosswise shape (an image 32″ of the mark 32 is shown in FIG. 6). For instance, when the application substrate 31 is the substrate of the liquid crystal display device 6 provided with black matrices 4, the alignment mark 32 is formed of a metal or other mark having opaque contrast.

To bring the hologram 20 in precise alignment with the application substrate 31, light from a white light source or a monochromatic light source 33, for instance, is converted by an optical system 34 into parallel light, which is then incident vertically on the side of the hologram 20 through a half-silvered mirror 35 and an objective 36. For the monochromatic light source 33, a laser may be used or a white lamp may be used in combination with a filter having the same wavelength range as the diffraction wavelength of the hologram alignment mark 22. Then, an superposed and magnified image of the hologram alignment mark 22 and alignment mark 32 is phototaken by a CCD 37 thorough the objective 36 to display the phototaken magnified image on a monitor screen 38. For the objective 36 it is desired to use a telecentric objective.

One example of the monitor screen is shown in FIG. 6. Light of a given wavelength determined depending on the spacing between the interference fringes 24 (FIG. 2(b)) is reflected from the hologram alignment mark 22 on the hologram 20 to display on the monitor screen the monochromatic and crosswise image 22″ of the hologram alignment mark 22, which represents the outside shape of the hologram alignment mark 22 and has high luminance. On the other hand, the same crosswise image 32″ is displayed as a background of the image 22″ from the alignment mark 32 on the application substrate 31. By controlling the positions of the hologram 20 and application substrate 31 to bring the crosswise shapes of the images 32″ and 22′ into position alignment with each other, it is thus possible to bring both into precise alignment with each other. When a monochromatic light source is used as the light source 33, it is to be noted that the light emission wavelength should be in agreement with the Bragg wavelength determined depending on the spacing between the interference fringes 24 forming the hologram alignment mark 22. Upon development of the photosensitive layer 13, the spacing between the interference fringes 24 becomes slightly narrow. It is thus required that the wavelength of the monochromatic light source 33 be given by λ(1−Δ) where λ is the wavelength of the laser light 29 upon recording, and Δ is the rate of shrinkage of the photosensitive layer 13. When a white light source is used as the light source 33, it is to be noted that there may be a slight lowering of the contrast of the images 22″ and 32″ of the alignment marks.

While the invention has been explained with reference to the alignment mark chromium pattern 28 having a crosswise outside shape, i.e., the hologram alignment mark 22 having a crosswise outside shape, it is understood that the hologram alignment mark 22 may have other various outside shapes, and three or more hologram alignment marks may be used. With these modifications, the alignment mark 32 on the application substrate 32, too, may be selected or modified as to shape and position.

While a transmission hologram is used as the main hologram 21 of the hologram 20, it is understood that the invention may also be applied to a reflection hologram.

Next, an account will be given of how to fabricate the hologram alignment mark 22 when a hologram product is fabricated by carrying out a hologram replication process using the replicated hologram as a hologram plate.

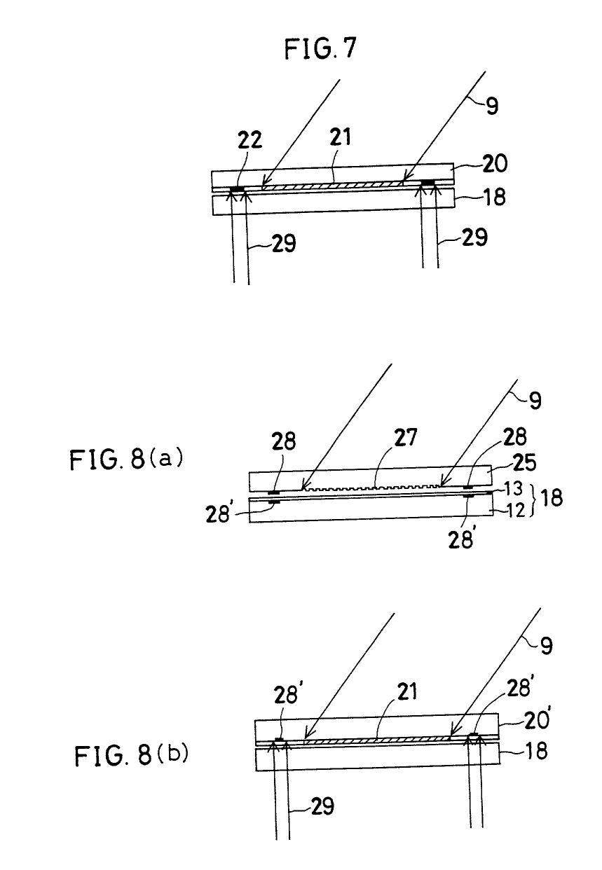

FIG. 7 is an illustration of how the main hologram 21 and hologram alignment marks 22 are replicated on another hologram photosensitive material 18 using as a hologram plate the hologram 20 replicated from the hologram plate 25 according to the arrangement shown in FIG. 3. In the FIG. 3 embodiment, the reflecting member provided on the plate 25 for the replication of the hologram alignment marks 22 is formed of the chromium pattern 28. In the FIG. 7 embodiment, however, the hologram alignment marks 22 are each a hologram of the reflection type recorded by light reflected from each chromium pattern 28. Upon development of the photosensitive layer 13 after the first replication in the FIG. 3 embodiment, the spacing between the interference fringes 24 forming each hologram alignment mark 22 becomes usually somewhat narrow, as already mentioned. It is thus required that the wavelength of the vertically incident laser light 29 for the replication of each hologram alignment mark 22 at the second replication time in the FIG. 7 embodiment be given by (1−Δ) where λ is the first wavelength, and Δ is the rate of shrinkage of the photosensitive layer 13.

FIG. 8 is a modification of the FIG. 7 embodiment. In this modification, laser light 9 is first incident from the hologram plate 25 on a region of the main hologram pattern 27 to replicate the main hologram 21 alone, as shown in FIG. 8(a). However, reflecting patterns 28′ having the same shape as that of each alignment mark chromium pattern 28 on the hologram plate 25 are provided on the glass substrate 12 in the hologram photosensitive material 18. The main hologram 21 is then replicated after the alignment of both using the alignment mark chromium patterns 28 on the hologram plate 25 and the reflecting patterns 28′ on the hologram photosensitive material 18.

As shown in FIG. 80(b), the main hologram 21 is then replicated as in the FIG. 7 embodiment, using the thus replicated hologram plate 20′. At the same time, the hologram alignment marks 22 are fabricated (or replicated) as in the FIG. 3 embodiment, using the reflecting patterns 28′.

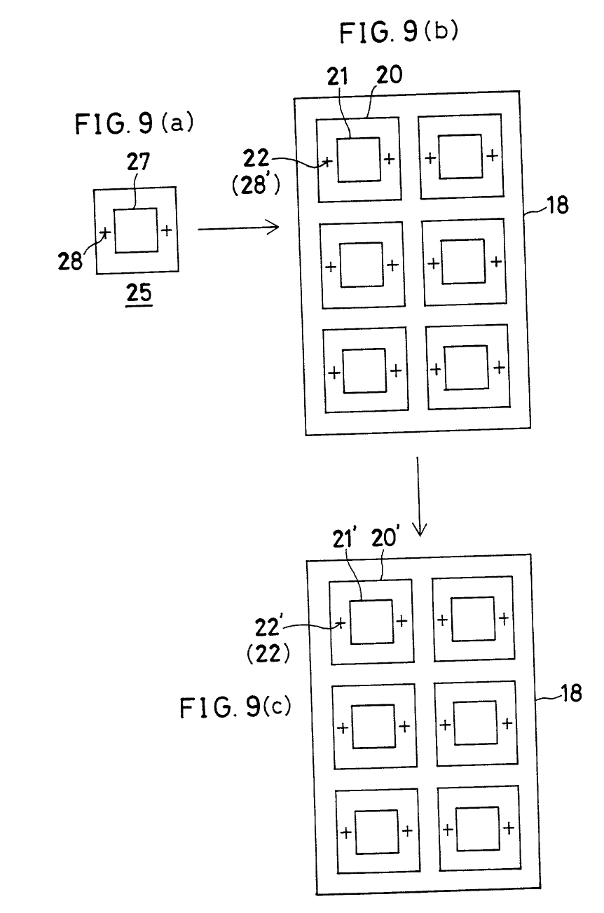

A difference between the FIG. 3+FIG. 4 method and the FIG. 8 method is that the amount of a blur of the hologram alignment mark 22′ in the end product (FIG. 9) is larger in the former than in the latter because the once fabricated hologram alignment mark 22 is again replicated.

In another modification, a reflecting pattern 28′ having a shape corresponding to the hologram alignment mark 22 on the hologram plate 20 is provided on the glass substrate 12 of another hologram photosensitive material 19 in the FIG. 7 replication embodiment, as shown in FIG. 8(a). After alignment of both using the hologram alignment marks 22 on the hologram plate 20 and the reflecting patterns 28′ on the hologram photosensitive material 18, the laser light 9 is incident on the region of the main hologram 21 to replicate the main hologram 21 alone.

Illustrated in FIG. 9 is an embodiment wherein the efficiency of using the hologram replicated from the first hologram plate as another hologram plate is improved by providing a plurality of holograms on a hologram photosensitive material. Using such a hologram plate 25 (see FIG. 3) as shown in FIG. 9(a), a plurality (six in this embodiment) of holograms 20 are arranged side by side on a large hologram photosensitive material 18 as shown in FIG. 9(b) for replication purposes. This replication may be carried out either by the FIG. 3 method or by the FIG. 8(a) method. Using the photosensitive material 18 with a plurality of holograms provided thereon as a hologram plate, a plurality of hologram 20 are then replicated at a time on another large photosensitive material 18, as shown in FIG. 9(c). In FIG. 9, 20′ represents a hologram fabricated at the second replication step, 21′ a main hologram, and 22′ a hologram alignment mark.

While the hologram alignment mark of the invention and its fabrication method have been described with reference to some preferred embodiments, it is understood that the invention is not limited thereto, and so various modification may be made thereto.

As can be understood from the foregoing, the present invention is an alignment mark which is provided on the same substrate as a hologram substrate and comprises a reflection hologram having a predetermined outside shape. Even when the replication process is repeated to fabricate holograms, it is thus unnecessary to provide another alignment mark on the glass substrate of the end product, because the alignment mark of the invention is unsusceptible to any displacement and is of high precision. The present invention also provides a method for fabricating such an alignment mark.

What we claim is:

1. A hologram alignment mark, which is provided on the same substrate as provided with a hologram and comprises a reflection hologram having a predetermined outside shape.

2. A hologram alignment mark according to claim 1, wherein said reflection hologram comprises interference fringes arranged parallel with one another on a hologram layer surface.

3. A hologram alignment mark according to claim 1 or 2, wherein the hologram provide on the same substrate as provided thereon with the alignment mark comprising said reflection hologram is a transmission hologram.

4. A hologram alignment mark fabrication method in which a reflecting member having a predetermined pattern is provided on the same substrate as that for a hologram plate to replicate a hologram from said hologram plate by a hologram replication process, wherein a reflection hologram having an outside shape corresponding to said pattern on said reflecting member is recorded at a position of a surface of said hologram replicated from said hologram plate by incidence of illumination light on said reflecting member, said position corresponding to said reflecting member.

5. A hologram alignment mark fabrication method according to claim 4, wherein said hologram plate comprises a phase hologram which is replicated by a transmission hologram replication process, and said reflecting member is a reflecting member provided at a position of a part of a surface of said phase hologram.

6. A method for reading a hologram alignment mark provided on the same substrate as provided with a hologram and comprising a reflection hologram having a predetermined outside shape, wherein a laser is used as an illumination light source for said reflection hologram.

7. A method for reading a hologram alignment mark provided on the same substrate as provided with a hologram and comprising a reflection hologram having a predetermined outside shape, wherein a white light source is used as an illumination light source for said reflection hologram in combination with a filter having a wavelength range substantially identical with a diffraction wavelength of said reflection hologram.
